(19) United States
(12) Patent Application Publication
(10) Pub. No.: US 2025/0305926 A1
(43) Pub. Date: Oct. 2, 2025

(54) PARTICLE MASS MEASUREMENT DEVICE AND OPERATING METHOD THEREOF

(71) Applicants: SAMSUNG ELECTRONICS CO., LTD., Suwon-si (KR); RESEARCH & BUSINESS FOUNDATION SUNGKYUNKWAN UNIVERSITY, Suwon-si (KR)

(72) Inventors: Ilhwan KIM, Suwon-si (KR); Changhyeon KIM, Suwon-si (KR); Kangyoon LEE, Suwon-si (KR)

(73) Assignees: SAMSUNG ELECTRONICS CO., LTD., Suwon-si (KR); RESEARCH & BUSINESS FOUNDATION SUNGKYUNKWAN UNIVERSITY, Suwon-si (KR)

(21) Appl. No.: 18/817,865

(22) Filed: Aug. 28, 2024

(30) Foreign Application Priority Data
Mar. 26, 2024 (KR) 10-2024-0041288

(51) Int. Cl. G01N 15/10

(52) U.S. Cl. CPC G01N 15/10; G01N 2015/1021; G01N 2015/1029

(57) ABSTRACT

There is provided a particle mass measurement device including a sensing channel that generates a sensing clock signal, a reference channel that generates a reference clock signal, a counter and a controller. The sensing channel includes a first surface acoustic wave (SAW) sensor that generates a SAW, a first amplifier that amplifies the SAW, and a first bias generator that applies a first bias voltage to the first amplifier. The reference channel includes a second SAW sensor that generates a SAW, a second amplifier that amplifies the SAW generated by the second SAW sensor, a second bias generator that applies a second bias voltage to the second amplifier. The counter generates a first output signal based on the sensing clock signal, and generates a second output signal based on the reference clock signal. The controller adjusts magnitude of the first bias voltage, or adjusts magnitude of the second bias voltage.

### CROSS-REFERENCE TO RELATED APPLICATION

This application is based on and claims priority under 35 U.S.C. § 119 to Korean Patent Application No. 10-2024-0041288, filed on Mar. 26, 2024, in the Korean Intellectual Property Office, the disclosure of which is incorporated by reference herein in its entirety.

### BACKGROUND

### 1. Field

The disclosure relates to a particle mass measurement device and an operating method of a particle mass measurement device.

### 2. Description of the Related Art

In related art, a particle mass measurement device are used to measure particles in the air. For example, such particles in the air may be molecular substances in a gaseous state, may be invisible substances that may be generated from combustion of fossil fuels, such as coal and oil, or may be discharged from manufacturing facilities or exhaust gases, such as automobile exhaust. Also, such particles may generally refer to particulate matter with a diameter of 10 μm or less.

Particles in the air may penetrate into the lungs and bloodstream of humans and cause environmental problems or health-related problems, such as DNA mutations, heart attacks, respiratory diseases, skin diseases, and eye diseases. In particular, ultrafine particles classified as particulate matter (PM) 2.5 (e.g., particles that are 2.5 micrometers or smaller in diameter) or less or ultra fine particles (UFPs) may penetrate deep into the bronchi and lungs in the human body and cause serious diseases.

In order to prevent environmental problems, health-related problems or other problems caused by particles, it is necessary to measure the mass or mass concentration of particles in the air. Accordingly, there is a need for a method of precisely measuring the mass or mass concentration of particles.

### SUMMARY

Generally, devices for measuring the mass (or mass concentration) of particles detect frequency change by using a surface acoustic wave (SAW) sensor according to the size of particles to be measured, and measure the mass of particles based on a change in frequency.

For example, a related art particle mass measurement device configures a sensing channel and a reference channel, each including a SAW sensor, and measures the mass of particles by detecting the frequency difference between the sensing channel and the reference channel through a mixer.

However, in the case of the method of detecting the frequency difference by using the mixer, power consumption may excessively increase in the process of measuring the mass of particles, and the range allowed to detect the frequency difference, that is, the resolution, is limited. Therefore, there is a need for a novel method capable of precisely detecting frequency difference while reducing power consumption.

Provided is a particle mass measurement device capable of precisely measuring the mass of particles with low power consumption by using a counter, compared to the case of measuring the mass of particles by using a mixer.

Meanwhile, each of the sensing channel and the reference channel constituting the particle mass measurement device includes the SAW sensor and an amplifier connected to the SAW sensor and forming a feedback loop. In an example case in which a system gain of each of the sensing channel and the reference channel is lower than 0 dB, because a SAW of the SAW sensor may not oscillate at a resonant frequency, an output frequency may not be obtained from each channel.

Provided is a particle mass measurement device capable of automatically adjusting a bias voltage applied to an amplifier constituting each channel such that an oscillation condition of a SAW sensor at the resonant frequency is satisfied in each of the sensing channel and the reference channel.

The technical problems of the disclosure are not limited to the above-described description, and other technical problems may be clearly understood by one of ordinary skill in the art from the specification and the attached drawings.

Additional aspects will be set forth in part in the description which follows and, in part, will be apparent from the description, or may be learned by practice of the presented embodiments of the disclosure.

According to an aspect of the disclosure, there is provided a particle mass measurement device including: a sensing channel including: a first surface acoustic wave (SAW) sensor configured to generate a first SAW, a first amplifier configured to amplify the first SAW generated by the first SAW sensor, and a first bias generator configured to apply a first bias voltage to the first amplifier, the sensing channel being configured to generate a sensing clock signal; a reference channel including: a second SAW sensor configured to generate a second SAW, a second amplifier configured to amplify the second SAW generated by the second SAW sensor, a second bias generator configured to apply a second bias voltage to the second amplifier, the reference channel being configured to generate a reference clock signal; a counter configured to: generate a first output signal based on the sensing clock signal, and generate a second output signal based on the reference clock signal; and a controller configured to: adjust a first magnitude of the first bias voltage based on the first output signal, or adjust a second magnitude of the second bias voltage based on the second output signal, calculate a difference in frequency between the sensing clock signal and the reference clock signal based on a difference between the first output signal and the second output signal, and measure a mass of particle based on the difference in frequency between the sensing clock signal and the reference clock signal.

According to another aspect of the disclosure, there is provided an operating method of a particle mass measurement device, the operating method may include: generating a sensing clock signal using a sensing channel by: generating, by a first surface acoustic wave (SAW) sensor, a first SAW, amplifying, by a first amplifier, the first SAW generated by the first SAW sensor, and applying, by a first bias generator, a first bias voltage to the first amplifier; generating a reference clock signal using a reference channel by: generating, by a second SAW sensor, a second SAW, amplifying, by a second amplifier, the second SAW generated by the second SAW sensor, applying, a second bias generator, a second bias voltage to the second amplifier; generating a first output signal using an asynchronous counter based on the sensing clock signal; generating a second output signal using the asynchronous counter based on the reference clock signal; adjusting, by a controller, a first magnitude of the first bias voltage based on the first output signal, or adjust a second magnitude of the second bias voltage based on the second output signal; calculating, by the controller, a difference in frequency between the sensing clock signal and the reference clock signal based on a difference between the first output signal and the second output signal; and measuring, by the controller, a mass of particle based on the difference in frequency between the sensing clock signal and the reference clock signal.

According to another aspect of the disclosure, there is provided a computer-readable recording medium having recorded thereon a program for implementing an operating method of a particle mass measurement device, the operating method including: generating a sensing clock signal using a sensing channel by: generating, by a first surface acoustic wave (SAW) sensor, a first SAW, amplifying, by a first amplifier, the first SAW generated by the first SAW sensor, and applying, by a first bias generator, a first bias voltage to the first amplifier; generating a reference clock signal using a reference channel by: generating, by a second SAW sensor, a second SAW, amplifying, by a second amplifier, the second SAW generated by the second SAW sensor, applying, a second bias generator, a second bias voltage to the second amplifier; generating a first output signal using an asynchronous counter based on the sensing clock signal; generating a second output signal using the asynchronous counter based on the reference clock signal; adjusting, by a controller, a first magnitude of the first bias voltage based on the first output signal, or adjust a second magnitude of the second bias voltage based on the second output signal; calculating, by the controller, a difference in frequency between the sensing clock signal and the reference clock signal based on a difference between the first output signal and the second output signal; and measuring, by the controller, a mass of particle based on the difference in frequency between the sensing clock signal and the reference clock signal.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 is a block diagram illustrating elements of a particle mass measurement device, according to an embodiment;

FIG. 2 is a circuit diagram illustrating elements of a particle mass measurement device, according to an embodiment;

FIG. 3 is a circuit diagram illustrating a sensing channel of a particle mass measurement device, according to an embodiment;

FIG. 4 is a graph showing frequency characteristics of a surface acoustic wave (SAW) sensor when particle with a first mass exists in the air;

FIG. 5 is a graph showing frequency characteristics of a SAW sensor when particle with a second mass exists in the air;

FIG. 6 is a circuit diagram illustrating a counter of a particle mass measurement device, according to an embodiment;

FIG. 7 is a graph showing a change in outputs of a plurality of flip-flops over time when a mask signal is applied to a counter of a particle mass measurement device, according to an embodiment;

FIG. 8 is a flowchart for describing operations, performed by a particle mass measurement device, of measuring the mass of particle, according to an embodiment;

FIG. 9 is a flowchart for describing an operation, performed by a particle mass measurement device, of calculating a difference in frequency between a sensing clock signal and a reference clock signal, according to an embodiment;

FIG. 10 is a flowchart for describing an operation of processing a first output signal and a second output signal, which are generated by a counter of a particle mass measurement device, according to an embodiment;

FIG. 11 is a flowchart for describing operations of adjusting magnitude of a bias voltage output by a bias generator according to an embodiment; and

FIG. 12 is a flowchart for describing operations of adjusting magnitude of a bias voltage output by a bias generator according to an embodiment.

### DETAILED DESCRIPTION

Reference will now be made in detail to embodiments, examples of which are illustrated in the accompanying drawings, wherein like reference numerals refer to like elements throughout. In this regard, the embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

With respect to the terms used to describe the various embodiments, general terms which are currently and widely used are selected in consideration of functions of structural elements in the various embodiments of the disclosure. However, meanings of the terms can be changed according to intention, a judicial precedence, the appearance of new technology, etc. In addition, in certain cases, a term which is not commonly used can be selected. In such a case, the meaning of the term will be described in detail at the corresponding portion in the description of the disclosure. Therefore, the terms used in the various embodiments of the disclosure should be defined based on the meanings of the terms and the descriptions provided herein.

Throughout the descriptions of embodiments, when an element is referred to as being “connected” or “coupled” to another element, it can be directly connected or coupled to the other element, or can be electrically connected or coupled to the other element with intervening elements provided therebetween. The terms “comprises” and/or “comprising” or “includes” and/or “including” when used in this specification, specify the presence of stated elements, but do not preclude the presence or addition of one or more other elements.

The terms “configured” or “include” used herein should not be construed as necessary including all of several elements or several steps written in the specification, but as not including some of the elements or steps or as further including additional elements or steps.

While such terms as “first”, “second”, etc., used herein may be used to describe various elements, such elements must not be limited to the above terms. The above terms are used only to distinguish one element from another.

The descriptions of embodiments below should not be construed as limiting the right scope of the accompanying claims, and it should be construed that all of the technical ideas included within the scope equivalent to the claims are included within the right scope of embodiments. The embodiments of the disclosure will now be described more fully with reference to the accompanying drawings.

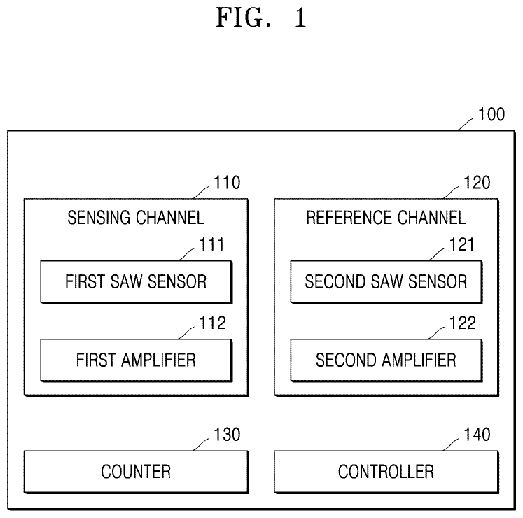

FIG. 1 is a block diagram illustrating elements of a particle mass measurement device 100, according to an embodiment.

Referring to FIG. 1, according to an embodiment, the particle mass measurement device 100 may include a sensing channel 110, a reference channel 120, a counter 130, and a controller 140. The particle mass measurement device 100 is a device for measuring the mass or mass concentration of particles in the air. For example, particles in the air may be a molecular substance in a gaseous state, may be an invisible substance that may be generated from combustion of fossil fuels, such as coal and oil, or may be discharged from manufacturing facilities or exhaust gases, such as automobile exhaust. The particles may generally refer to a particulate matter with a diameter of 10 μm or less. According to an embodiment, the particle mass measurement device 100 may be referred to as a “particle mass concentration measurement device”, but the disclosure is not limited thereto.

According to an embodiment, the sensing channel 110 may be a circuit that operates as an oscillator. For example, the sensing channel 110 may generate a sensing clock signal for measuring the mass (or “mass concentration”) of particles in the air.

According to an embodiment, the sensing channel 110 may include a first surface acoustic wave (SAW) sensor 111 and a first amplifier 112. The first SAW sensor may generate a SAW and the first amplifier 112 may amplify the SAW generated by the first SAW sensor 111. For example, the sensing channel 110 may be a circuit implemented as the first SAW sensor 111 and the first amplifier 112. According to one or more embodiments, the “SAW” may refer to a kind of acoustic wave propagating along the surface, and frequency characteristics of the SAW may change as the mass or mass concentration of particles in the air changes.

The first SAW sensor 111 may include a piezoelectric material, and may generate a SAW having a certain frequency as a voltage is applied to the first SAW sensor 111. For example, the first SAW sensor 111 may generate a SAW having a specific resonant frequency as a voltage is applied to first SAW sensor 111.

The first amplifier 112 may amplify the SAW generated by the first SAW sensor 111. For example, the first amplifier 112 may be a radio frequency (RF) amplifier having a certain gain. For example, the certain gain may be about 35 dB or more. However, the disclosure is not limited thereto, and as such, the gain may be of another range.

The first amplifier 112 may be electrically connected to the first SAW sensor 111 such that a system gain of the sensing channel 110 satisfies an oscillation condition at a resonant frequency of the first SAW sensor 111. For example, the first amplifier 112 may be electrically connected to the first SAW sensor 111 and may form a feedback loop. A configuration of the sensing channel 110 will be described in detail below.

According to one or more embodiments, the “oscillation condition” may refer to a gain condition of a system for oscillation of the SAW at the resonant frequency, and the corresponding expression may be used in the same meaning hereinafter. In an example case in which the total gain of the system for generating the SAW is 0 dB or more, the SAW of the SAW sensor may oscillate at the resonant frequency, but the disclosure is not limited thereto.

According to an embodiment, the reference channel 120 may be an oscillator similar to or same as the sensing channel 110. The reference channel 120 may generate a reference clock signal that is a reference for detecting a change in the mass of particles in the air.

According to an embodiment, the reference channel 120 may include a second SAW sensor 121 and a second amplifier 122. For example, the second SAW sensor 121 may generate a SAW and the second amplifier 122 may amplify frequency of the SAW generated by the second SAW sensor 121. For example, the reference channel 120 may be a circuit implemented as the second SAW sensor 121 and the second amplifier 122, which is substantially the same as or similar to the sensing channel 110.

The second SAW sensor 121 may include a piezoelectric material, and may generate a SAW having a certain frequency as a voltage is applied to the second SAW sensor 121. For example, the second SAW sensor 121 may generate a SAW having a specific frequency as a voltage is applied to the second SAW sensor 121.

The second amplifier 122 may amplify the SAW generated by the second SAW sensor 121. For example, the second amplifier 122 may be an RF amplifier having a certain gain. For example, the certain gain may be about 35 dB or more. However, the disclosure is not limited thereto, and as such, the gain may be of another range.

The second amplifier 122 may be electrically connected to the second SAW sensor 121 such that a system gain of the reference channel 120 satisfies an oscillation condition of the second SAW sensor 121 at the resonant frequency. For example, the second amplifier 122 may be electrically connected to the second SAW sensor 121 and may form a feedback loop. A configuration of the reference channel 120 will be described in detail below.

According to an embodiment, the counter 130 may be a circuit for counting received clock signals. For example, the counter 130 may be configured to count the sensing clock signal and the reference clock signal. For example, the counter 130 may be electrically connected to the sensing channel 110 and the reference channel 120, respectively receive the sensing clock signal and the reference clock signal from the sensing channel 110 and the reference channel 120, and count the number of pulses of the received sensing clock signal and the received reference clock signal.

In an example, the counter 130 may be electrically connected to an output terminal of the sensing channel 110, receive the sensing clock signal from the sensing channel 110, and count the number of pulses of the received sensing clock signal. In another example, the counter 130 may be electrically connected to an output terminal of the reference channel 120, receive the reference clock signal from the reference channel 120, and count the number of pulses of the received reference clock signal.

The controller 140 may control overall operations of the particle mass measurement device 100. For example, the controller 140 may include at least one processor. The processor may be implemented as an array of a plurality of logic gates, or implemented as a combination of a general-purpose microprocessor and a memory in which programs executable by the microprocessor are stored. According to an embodiment, one of ordinary skill in the art may understand that the controller 140 may be implemented in other types of hardware.

According to an embodiment, the controller 140 may be electrically connected to the counter 130, control a counting operation of the counter 130, and measure the mass or mass concentration of particles in the air based on a counting result of the counter 130.

In an example, the controller 140 may control the counting operation of the counter 130 by generating a mask signal for controlling the beginning (e.g., the start) and the end (e.g., the stop) of the counting operation of the counter 130 and transmitting the generated mask signal to the counter 130.

In another example, the controller 140 may calculate a difference in frequency between the sensing clock signal and the reference clock signal by comparing a first number of clocks of the sensing clock signal received from the counter 130 with a second number of clocks of the reference clock signal received from the counter 130, and measure the mass or mass concentration of particles in the air based on the calculated difference in frequency between the sensing clock signal and the reference clock signal. An operation, performed by the controller 140, of estimating the mass or mass concentration of particles in the air will be described in detail below.

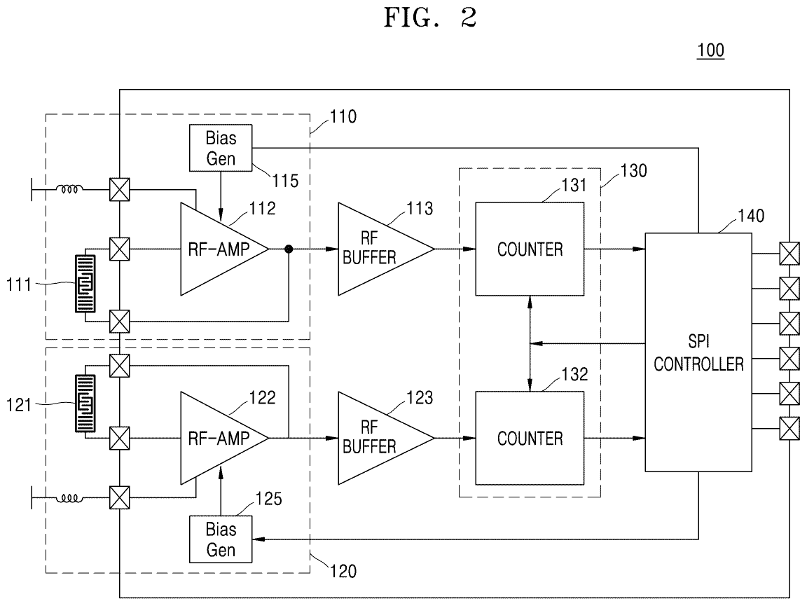

FIG. 2 is a circuit diagram illustrating elements of the particle mass measurement device 100, according to an embodiment. According to an embodiment, one or more of the elements of the particle mass measurement device 100 illustrated in FIG. 2 may be substantially same as or similar to one or more of the elements of the particle mass measurement device 100 illustrated in FIG. 1, and as such, a redundant description thereof may be omitted.

Referring to FIG. 2, the particle mass measurement device 100 according to an embodiment may include the sensing channel 110, the reference channel 120, the counter 130, and the controller 140. The elements of the particle mass measurement device 100 are not limited to the embodiment described above. As such, according to an embodiment, one or more other may be added, or any one element may be omitted. For example, the particle mass measurement device 100 may include a first buffer 113 and a second buffer 123.

The sensing channel 110, which is a channel for measuring the mass of an actual particle, may include a first SAW sensor 111, a first amplifier 112, and a first bias generator 115.

The first amplifier 112 may have a certain gain. The gain of the first amplifier 112 may be adjusted according to a first bias voltage supplied by the first bias generator 115. The gain of the first amplifier 112 may be linearly proportional to the first bias voltage supplied by the first bias generator 115 within a certain range.

The first bias voltage output by the first bias generator 115 may be adjusted according to a control signal received from the controller 140. For example, the first bias generator 115 may generate the first bias voltage with a voltage level based on a first trim value output by the controller 140.

The first trim value may have an analog value or a digital value. A level of the first bias voltage may be determined according to the first trim value. In an example case in which the first trim value has the analog value, the first trim value may be “0” to “7”. In an example case in which the first trim value has the digital value, the first trim value may have a plurality of bit values. In an example case in which the first trim value has a 3-bit value, the first trim value may be “000” to “111”.

The sensing channel 110 may generate a sensing clock signal by amplifying a SAW generated by the first SAW sensor 111. For example, the sensing channel 110 may be implemented in a circuit form in which the first SAW sensor 111 and the first amplifier 112 (e.g., an RF-AMP of FIG. 2) form a feedback loop such that a system gain of the sensing channel 110 satisfies an oscillation condition of the first SAW sensor 111. The controller 140 may adjust the gain of the first amplifier 112 through the first trim value, and allow the system gain of the sensing channel 110 to satisfy the oscillation condition of the first SAW sensor 111 at the resonant frequency.

The reference channel 120 may be a channel symmetrically configured with the sensing channel 110 for comparison with the sensing channel 110. The reference channel 120 may include a second SAW sensor 121, a second amplifier 122, and a second bias generator 125.

The second amplifier 122 may have a certain gain. The gain of the second amplifier 122 may be adjusted according to a second bias voltage supplied by the second bias generator 125. The gain of the second amplifier 122 may be linearly proportional to the second bias voltage supplied by the second bias generator 125 within a certain range.

The second bias voltage output by the second bias generator 125 may be adjusted according to a control signal received from the controller 140. For example, the second bias generator 125 may generate the second bias voltage with a voltage level based on a second trim value output by the controller 140. The second trim value may have an analog value or a digital value, and a level of the second bias voltage may be determined according to the second trim value.

The reference channel 120 may generate a reference clock signal by amplifying a SAW generated by the second SAW sensor 121. For example, the reference channel 120 may be implemented in a circuit form in which the second SAW sensor 121 and the second amplifier 122 (e.g., the RF-AMP of FIG. 2) form a feedback loop such that a system gain of the reference channel 120 satisfies an oscillation condition of the second SAW sensor 121. The controller 140 may adjust the gain of the second amplifier 122 through the second trim value, and allow the system gain of the reference channel 120 to satisfy the oscillation condition of the second SAW sensor 121 at the resonant frequency. The particle mass measurement device 100 according to an embodiment may further include a first buffer 113 and a second buffer 123. For example, the first buffer 113 may stabilize the voltage of the sensing clock signal generated by the sensing channel 110 and the second buffer 123 may stabilize the voltage of the reference clock signal generated by the reference channel 120. For example, the particle mass measurement device 100 may include the first buffer 113 provided on an electrical path between the sensing channel 110 and the counter 130, and the second buffer 123 provided on an electrical path between the reference channel 120 and the counter 130.

The first buffer 113 may have one end connected to an output terminal of the sensing channel 110 and the other end connected to an input terminal of the counter 130, and adjust the voltage of the sensing clock signal transmitted from the sensing channel 110 to the counter 130.

The second buffer 123 may have one end connected to an output terminal of the reference channel 120 and the other end connected to the input terminal of the counter 130, and adjust the voltage of the reference clock signal transmitted from the reference channel 120 to the counter 130. However, the disclosure is not limited thereto, and as such, according to an embodiment, only one of the first buffer 113 and the second buffer 123 may be provided.

In an example case in which the operating voltage of the counter 130 is different from the voltage of the sensing clock signal and/or the reference clock signal, and the sensing clock signal and/or the reference clock signal are/is directly transmitted to the counter 130, noise may occur in the sensing clock signal and/or the reference clock signal due to the voltage difference.

The particle mass measurement device 100 according to an embodiment may lower the voltage of the sensing clock signal through the first buffer 113, thereby reducing the difference between the sensing clock signal and the operating voltage of the counter 130. Also, the particle mass measurement device 100 according to an embodiment may lower the voltage of the reference clock signal through the second buffer 123, thereby reducing the difference between the reference clock signal and the operating voltage of the counter 130. Accordingly, the particle mass measurement device 100 according to an embodiment may reduce noise occurring in a process of inputting the sensing clock signal and/or the reference clock signal to the counter 130.

The counter 130 may receive the sensing clock signal having passed through the first buffer 113 and/or the reference clock signal having passed through the second buffer 123, and count the sensing clock signal and/or the reference clock signal based on the mask signal received from the controller 140. For example, the counter 130 may be an asynchronous counter including a plurality of flip-flops. However, the disclosure is not limited thereto. As such, in another embodiment, the counter 130 may be a synchronous counter.

In an example case in which the mask signal is received from the controller 140, the counter 130 may start counting the number of clocks of the sensing clock signal and/or the reference clock signal. In an example case in which the mask signal is not received from the controller 140, the counter 130 may stop counting the number of clocks of the sensing clock signal and/or the reference clock signal.

According to an embodiment, the counter 130 may include a first counter 131 electrically connected to the sensing channel 110 and a second counter 132 electrically connected to the reference channel 120.

The first counter 131 may be electrically connected to the output terminal of the sensing channel 110 through the first buffer 113, and may generate a first output signal by counting the sensing clock signal transmitted from the sensing channel 110.

The second counter 132 may be electrically connected to the output terminal of the reference channel 120 through the second buffer 123, and may generate a second output signal by counting the reference clock signal transmitted from the reference channel 120.

In this regard, the first counter 131 may generate the first output signal in the form of a digital signal from the sensing clock signal, and the second counter 132 may generate the second output signal in the form of a digital signal from the reference clock signal. The generated first output signal and/or the generated second output signal may be transmitted to the controller 140 electrically connected to the first counter 131 and/or the second counter 132.

The controller 140 may control the counting operation of the counter 130 and may measure the mass or mass concentration of particles in the air based on the first output signal and/or the second output signal received from the counter 130.

In an example, the controller 140 may control the counting operation of the counter 130 by generating a mask signal for controlling the start and stop of the counting operation of the counter 130 and a reset signal for resetting the counter 130. The controller 140 may transmit the generated mask signal and/or the generated reset signal to the counter 130. For example, the controller 140 may control a counting operation time of the counter 130 by adjusting a length of the mask signal. However, the disclosure is not limited thereto, and as such, the controller 140 may control the counting operation time of the counter 130 in another manner.

In another example, the controller 140 may calculate a difference in frequency between the sensing clock signal and the reference clock signal by comparing the first output signal and the second output signal received from the counter 130, and may measure the mass or mass concentration of particles in the air based on the calculated difference in frequency. For example, the controller 140 may measure the mass or mass concentration of particle by calculating a difference in frequency between the sensing clock signal and the reference clock signal based on the difference between the first output signal and the second output signal output as digital signals, and estimating a change in mass of current particle with respect to mass of the existing particle based on the calculated difference in frequency.

The particle mass measurement device 100 according to an embodiment may be implemented in the form of system on chip (SoC). That is, the elements of the particle mass measurement device 100 may be implemented in the form of being integrated into or mounted on a single chip. Accordingly, the particle mass measurement device 100 according to an embodiment may be miniaturized, compared to the particle mass measurement device of the related art.

In an example case in which the particle mass measurement device 100 is implemented in provided form of SoC, the sensing channel 110 and the reference channel 120 may be provided adjacent to each other. As a result, in an example case in which the sensing channel 110 and the reference channel 120 operate simultaneously, noise may occur in the sensing clock signal due to the reference clock signal, or noise may occur in the reference clock signal due to the sensing clock signal.

Since noise occurring in the sensing clock signal and/or the reference clock signal may deteriorate the accuracy of particle mass measurement, the particle mass measurement device 100 according to an embodiment may generate the sensing clock signal and the reference clock signal at certain time intervals, thereby preventing deterioration in the accuracy of particle mass measurement due to noise.

For example, the controller 140 of the particle mass measurement device 100 may control the sensing channel 110 to generate the sensing click signal after a specified time has elapsed from the time when the reference clock signal is generated by the reference channel 120. On the other hand, the controller 140 may control the reference channel 120 to generate the reference clock signal after a specified time has elapsed from the time when the sensing clock signal is generated by the sensing channel 110.

For example, the particle mass measurement device 100 according to an embodiment may generate the sensing clock signal and the reference clock signal at particular time intervals, thereby reducing noise occurring due to mutual interference between the sensing clock signal and the reference clock signal. For example, the particle mass measurement device 100 according to an embodiment may generate the sensing clock signal and the reference clock signal at different time intervals. As a result, even when the particle mass measurement device 100 is implemented in the form of SoC, the particle mass measurement device 100 may precisely measure the mass or mass concentration of particle.

The controller 140 may adjust the gain of the first amplifier 112 constituting the sensing channel 110 based on the first output signal received from the counter 130, thereby adjusting the system gain of the sensing channel 110 to satisfy the oscillation condition. Also, the controller 140 may adjust the gain of the second amplifier 122 constituting the reference channel 120, based on the second output signal received from the counter 130, thereby adjusting the system gain of the reference channel 120 to satisfy the oscillation condition. For example, the controller 140 may adjust the first bias voltage output by the first bias generator 115 and/or the second bias voltage output by the second bias generator 125, based on the first output signal and/or the second output signal received from the counter 130, thereby adjusting the gain of the first amplifier 112 constituting the sensing channel 110 and/or the second amplifier 122 constituting the reference channel 120.

For example, the controller 140 may compare the first output signal received from the counter 130 with a first reference value, increase the first trim value input to the first bias generator 115, and output the first trim value based on the first output signal being less than the first reference value. For example, the first trim value may be increase by one step (or one unit). In an example case in which the system gain of the sensing channel 110 does not satisfy the oscillation condition of the first SAW sensor 111, the sensing clock signal may not be generated, and as a result, the first output signal received from the counter 130 may have a small value. In an example case in which the first output signal received from the counter 130 is less than the first reference value, the controller 140 may determine that the system gain of the sensing channel 110 does not satisfy the oscillation condition of the first SAW sensor 111, increase and output the first trim value transmitted to the first bias generator 115 so that the first bias voltage supplied by the first bias generator 115 to the first amplifier 112 increases.

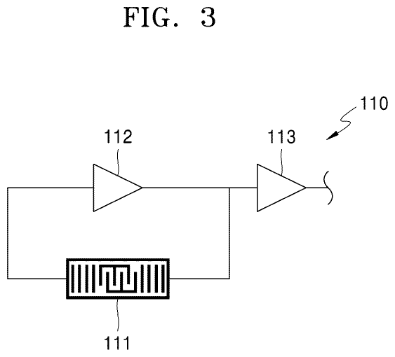

In a similar manner, the controller 140 may compare the second output signal received from the counter 130 with a second reference value, increase the second trim value input to the second bias generator 125 by one step, and output the second trim value based on the second output signal is less than the second reference value. For example, the second trim value may be increase by one step (or one unit). In an example case in which the system gain of the sensing channel 110 does not satisfy the oscillation condition of the second SAW sensor 111, the sensing clock signal may not be generated, and as a result, the second output signal received from the counter 130 may have a small value. When the second output signal received from the counter 130 is less than the second reference value, the controller 140 may determine that the system gain of the sensing channel 110 does not satisfy the oscillation condition of the second SAW sensor 121, increase and output the second trim value transmitted to the second bias generator 125 so that the second bias voltage supplied by the second bias generator 125 to the second amplifier 122 increases. Hereinafter, the sensing channel 110 and/or the reference channel 120 will be described in detail with reference to FIGS. 3 to 5.

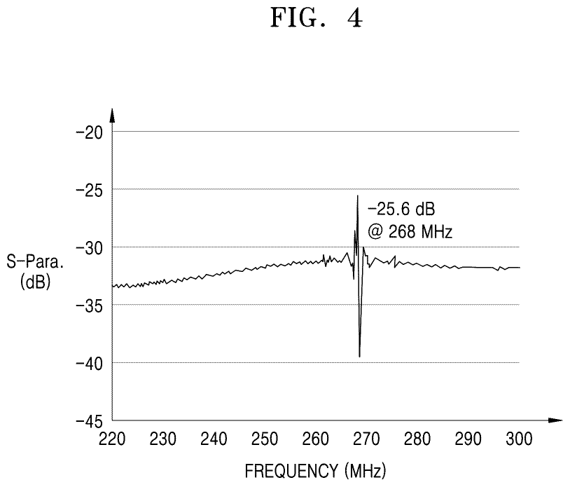

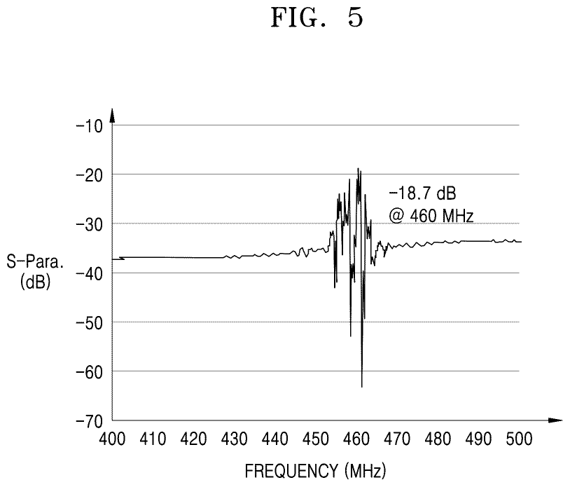

FIG. 3 is a circuit diagram illustrating the sensing channel 110 of the particle mass measurement device 100, according to an embodiment. In addition, FIG. 4 is a graph showing frequency characteristics (e.g., S parameter) of a SAW sensor when a particle with a first mass exists in the air, and FIG. 5 is a graph showing frequency characteristics of the SAW sensor when a particle with a second mass exists in the air.

At this time, FIG. 4 shows frequency characteristics of the first SAW sensor 111 for measuring a particle of PM 2.5 in the air, and FIG. 5 shows frequency characteristics of the first SAW sensor 111 for measuring a particle of PM 1.0 in the air.

Referring to FIG. 3, the sensing channel 110 of the particle mass measurement device (e.g., the particle mass measurement device 100 of FIG. 2) according to an embodiment may include the first SAW sensor 111 and the first amplifier 112.

The sensing channel 110 may be implemented as a circuit that forms a feedback loop between the first SAW sensor 111 and the first amplifier 112 in order to satisfy an oscillation condition of the first SAW sensor 111 at the resonant frequency.

Referring to FIGS. 4 and 5, the first SAW sensor 111 may be designed to oscillate at different resonant frequencies depending on the size of particles in the air.

In an example, as illustrated in FIG. 4, in a case in which the size of particles in the air is PM 2.5, when the frequency of the first SAW sensor 111 is about 268 MHz, the value of an S parameter S21 rises rapidly to −25.6 dB. As such, it may be confirmed that the resonant frequency of the first SAW sensor 111 is about 268 MHz in the corresponding condition.

In another example, as illustrated in FIG. 5, in a case in which the size of particles in the air is PM 1.0, when the frequency of the first SAW sensor 111 is about 460 MHz, the value of the S parameter S21 rises rapidly to −18.7 dB. As such, it may be confirmed that the resonant frequency of the first SAW sensor 111 is about 460 MHz in the corresponding condition.

The resonant frequency of the first SAW sensor 111 changes as the mass concentration of particles in the air changes. In this regard, when the system gain of the sensing channel 110 is lower than 0 dB at the resonant frequency, the first SAW sensor 111 may not oscillate at the resonant frequency.

The sensing channel 110 of the particle mass measurement device according to an embodiment may implement a feedback loop through the first SAW sensor 111 and the first amplifier 112 including a metal-oxide semiconductor field effect transistor (MOSFET) and a filter, and the controller 112 may automatically adjust the bias voltage applied to the first amplifier 112 such that the system gain of the sensing channel 110 may maintain 0 dB or more. Through the circuit structure described above, the sensing channel 110 of the particle mass measurement device 100 according to an embodiment may maintain the oscillation condition even when the mass concentration of particles in the air changes and thus the resonant frequency changes, thereby stably generating the sensing clock signal.

Although FIG. 3 illustrates the structure of the sensing channel 110, the disclosure is not limited thereto, and as such, the reference channel (e.g., the reference channel 120 of FIG. 2) of the particle mass measurement device 100 may have a symmetrical structure with the sensing channel 110, and be implemented in a structure substantially identical to or similar to that of the sensing channel 110. For example, in the reference channel 120, the second SAW sensor (e.g., the second SAW sensor 121 of FIG. 2) and the second amplifier (e.g., the second amplifier 122 of FIG. 2) may form a feedback loop, and the controller 140 may automatically adjust a bias voltage applied to the second amplifier 122, such that the system gain of the reference channel 120 may maintain 0 dB or more. A redundant description thereof is omitted.

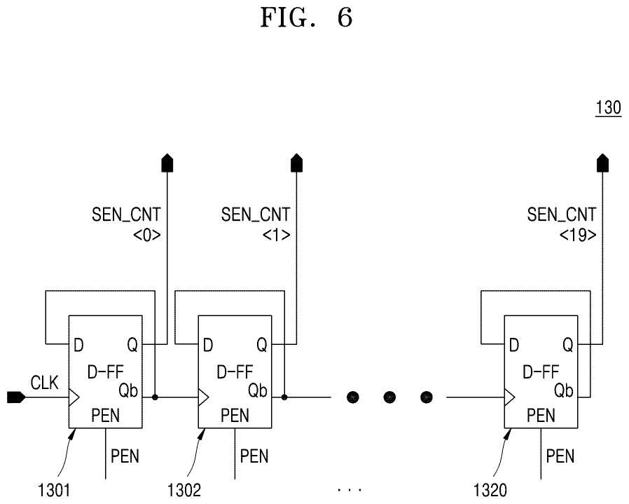

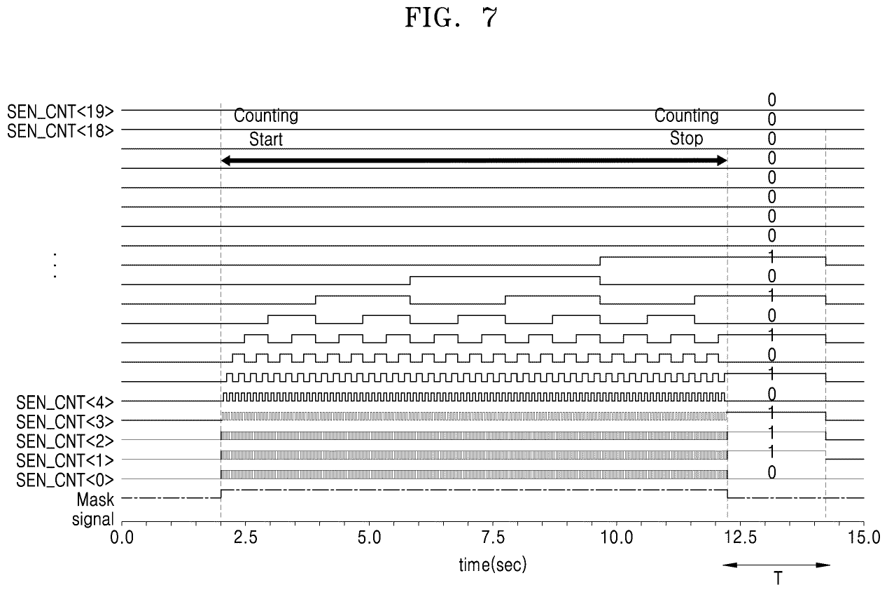

Hereinafter, the operation, performed by the counter (e.g., the counter 130 of FIG. 2), of counting the sensing clock signal and the reference clock signal will be described in detail with reference to FIGS. 6 and 7.

FIG. 6 is a circuit diagram illustrating the counter 130 of a particle mass measurement device, according to an embodiment. The counter 130 illustrated in FIG. 6 may be an embodiment of the first counter 131 or the second counter 132 of the particle mass measurement device 100 illustrated in FIG. 2, and a redundant description thereof is omitted.

Referring to FIG. 6, the counter 130 of the particle mass measurement device (e.g., the particle mass measurement device 100 of FIG. 2) according to an embodiment may include an asynchronous counter including a plurality of flip-flops. For example, the counter 130 may be an asynchronous counter implemented by a plurality of D-flip-flops. FIG. 6 illustrates an embodiment in which the counter 130 is a 20-bit asynchronous counter implemented by 20 D-flip-flops 1301, 1302, . . . , 1320, but the number of flip-flops is not limited to the illustrated embodiment.

The asynchronous counter may be a counter in which an output of one of a flip-flops connected in sequence is utilized as a clock signal of a next flipflop. In an example case in which the counter 130 is an asynchronous counter, an output signal (e.g., SEN_CNT<0> in FIG. 6) generated by the first flip-flop 1301 may be input as a clock signal of the second flip-flop 1302 as a sensing clock signal or a reference clock signal is input. In addition, an output signal (e.g., SEN_CNT<N−2>) of an N−1 flip-flop (where N is a natural number greater than or equal to 2) may be input as a clock signal of an N^{th} flipflop. As a result, output signals may be sequentially generated from the plurality of flip-flops by the input of the sensing clock signal or the reference clock signal.

According to one or more embodiments, a ‘first output signal generated by the counter 130 based on the sensing clock signal’ may refer to a set of output signals generated by the plurality of flip-flops 1301, 1302, . . . , 1320 when the sensing clock signal is input to the first flip-flop 1301. For example, the first output signal may refer to a set of output signals of a binary format generated by the plurality of flip-flops 1301, 1302, . . . , 1320 by the input of the sensing clock signal.

According to one or more embodiments, a ‘second output signal generated by the counter 130 based on the reference clock signal’ may refer to a set of output signals generated by the plurality of flip-flops 1301, 1302, . . . , 1320 when the reference clock signal is input to the first flip-flop 1301. For example, the second output signal may refer to a set of output signals of a binary format generated by the plurality of flip-flops 1301, 1302, . . . , 1320 by the input of the reference clock signal.

The particle mass measurement device according to an embodiment may implement the counter 130 with a simple circuit through the asynchronous counter implemented by N flip-flops, compared to a synchronous counter, and adjust the number of N flip-flops to improve the resolution performance (or ‘resolution’) of the particle mass measurement device. For example, the particle mass measurement device may have a resolution of 1 ppm or less by utilizing 20 flip-flops, and, as a result, thereby more accurately measuring the mass or mass concentration of particle.

Hereinafter, an operation, performed by a plurality of flip-flops, of generating output signals as a mask signal and a clock signal (e.g., a sensing clock signal or a reference clock signal) are input to the counter 130 illustrated in FIG. 6 will be described in detail with reference to FIG. 7.

FIG. 7 is a graph showing a change in outputs of a plurality of flip-flops over time when a mask signal is applied to a counter of a particle mass measurement device, according to an embodiment. Hereinafter, the graph of FIG. 7 is described with reference to the elements of the counter 130 illustrated in FIG. 6.

Referring to FIG. 7, in an example case in which the mask signal is received from the controller (e.g., the controller 140 of FIG. 2), the counter 130 of the particle mass measurement device according to an embodiment may perform an operation of counting the number of clocks of a clock signal input to the counter 130.

According to an embodiment, the counter 130 may be an asynchronous counter including the plurality of flip-flops 1301, 1302, . . . , 1320. In an example case in which the mask signal is applied to the counter 130, the plurality of flip-flops 1301, 1302, . . . , 1320 may sequentially count the number of clocks of the clock signal.

In an example case in which the mask signal is applied to the counter 130, the first flip-flop 1301 may count the number of clocks of the clock signal (e.g., a sensing clock signal or a reference clock signal) and generate an output signal SEN_CNT<0>.

In addition, the output signal SEN_CNT<0> of the first flip-flop 1301 may be input to the second flip-flop 1302 as the clock signal, and the second flip-flop 1302 may count the number of clocks of the output signal SEN_CNT<0> of the first flip-flop 1301 and generate an output signal SEN_CNT<1>. In such a manner, an output signal (e.g., SEN_CNT<N−2>) of an N−1 flip-flop (where N is a natural number greater than or equal to 2) may be input as a clock signal of an N flip-flop, and, as a result, the plurality of flip-flops 1301, 1302, . . . , 1320 may sequentially generate the output signals.

A controller of the particle mass measurement device according to an embodiment may receive an output signal (e.g., a first output signal or a second output signal) from the counter 130 after a specified time (e.g., T in FIG. 7) has elapsed from the time when an input of the mask signal ends, considering characteristics that an output signal of a previous flip-flop of the asynchronous counter is an input signal of a next flipflop. According to one or more embodiments, the ‘specified time T’ may refer to a delay or an offset of an output signal caused by characteristics of the asynchronous counter, and the corresponding expression may be used in the same meaning below.

As illustrated in FIG. 7, due to characteristics of the asynchronous counter, even when the input of the mask signal to the counter 130 is stopped, the output signals of the plurality of flip-flops 1301, 1302, . . . , 1320 may maintain constant values during the specified time T.

Accordingly, the controller of the particle mass measurement device according to an embodiment may receive the output signal (e.g., the first output signal or the second output signal) from the counter 130 after the specified time T has elapsed from the time when an counting operation of the counter 130 is stopped due to stop of the input of the mask signal.

For example, as illustrated in FIG. 7, the controller of the particle mass measurement device may receive an output signal of a binary format ‘00000000101010101110’ after the specified time T has elapsed from the time when the counting operation of the counter 130 is stopped (e.g., a counting stop time in FIG. 7). However, the disclosure is not limited thereto.

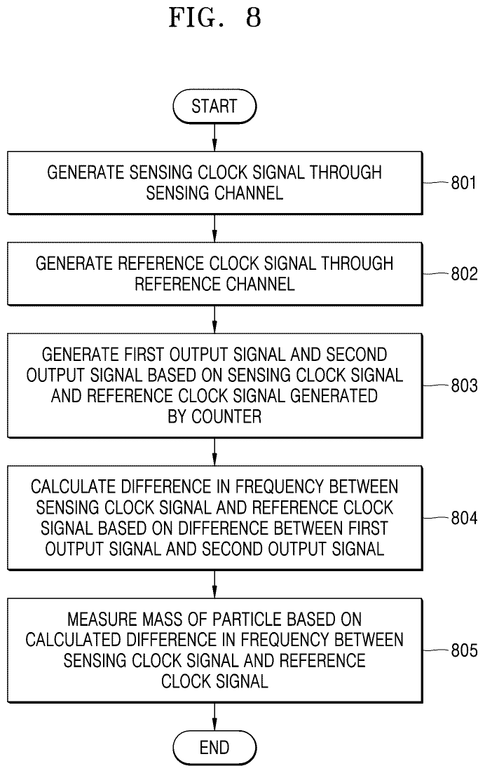

The controller of the particle mass measurement device according to an embodiment may reset the counter 130 to measure the mass of particles in the air, or count the number of clocks of a new clock signal based on the received output signal of the counter 130. Hereinafter, operations, performed by the particle mass measurement device, of measuring the mass of particle will be described in detail with reference to FIGS. 8 to 12.

FIG. 8 is a flowchart for describing operations, performed by the particle mass measurement device 100, of measuring the mass of particle, according to an embodiment. Hereinafter, the operations of measuring the mass of particles in FIG. 8 will be described with reference to the elements of the particle mass measurement device 100 illustrated in FIG. 2.

Referring to FIG. 8, in operation 801, the method may include generating a sensing clock signal. For example, the particle mass measurement device 100 according to an embodiment may generate a sensing clock signal through the sensing channel 110. For example, the sensing channel 110 may generate the sensing clock signal by amplifying a SAW generated by the first SAW sensor 111 through the first amplifier 112, and may transmit the generated sensing clock signal to the counter 130. In this regard, the sensing clock signal may refer to a clock signal having a resonant frequency which changes according to a change in the mass or mass concentration of particles in the air. The corresponding expression may be used in the same meaning below.

In operation 802, the method may include generating reference clock signal. For example, the particle mass measurement device 100 according to an embodiment may generate a reference clock signal through the reference channel 120. For example, the reference channel 120 may generate the reference clock signal by amplifying a SAW generated by the second SAW sensor 121 through the second amplifier 122, and may transmit the generated reference clock signal to the counter 130. In this regard, unlike the sensing clock signal, the reference clock signal may refer to a clock signal having a constant resonant frequency, regardless of a change in the mass or mass concentration of particle, and the corresponding expression may be used in the same meaning below.

According to an embodiment, the particle mass measurement device 100 may perform operations 801 and 802 at certain time intervals in order to prevent noise from occurring in a process of generating the reference clock signal due to the sensing clock signal, or to prevent noise from occurring in the reference clock signal in a process of generating the sensing clock signal.

For example, the particle mass measurement device 100 may perform operation 802 after a specified time has elapsed from the time when operation 801 is performed, or may perform operation 801 after a specified time has elapsed from the time when operation 802 is performed. For example, the particle mass measurement device 100 may perform operation 802 after a specified time has elapsed from the time when operation 801 is completed, or may perform operation 801 after a specified time has elapsed from the time when operation 802 is completed.

The sensing clock signal and the reference clock signal are generated at set time intervals, and thus, mutual interference between the sensing clock signal and the reference clock signal may be prevented, and as a result, the particle mass measurement device 100 may prevent the accuracy of particle mass measurement from deteriorating due to noise.

In operation 803, the method may include generating a first output signal based on the sensing clock signal and a second output signal based on the reference clock signal. For example, the particle mass measurement device 100 according to an embodiment may generate a first output signal and a second output signal based on the sensing clock signal generated by the counter 130 in operation 801 and/or the reference clock signal generated by the counter 130 in operation 802.

In an example, the counter 130 may generate the first output signal by counting the number of clocks of the sensing clock signal received from the sensing channel 110. In another example, the counter 130 may generate the second output signal by counting the number of clocks of the reference clock signal received from the reference channel 120. In this regard, the first output signal and the second output signal each may be generated in the form of a digital signal, and may be transmitted to the controller 140.

According to an embodiment, the counter 130 may include an asynchronous counter including a plurality of flip-flops (e.g., D-flip-flops), but a type of counter 130 is not limited thereto.

In operation 804, the method may include, calculating a difference in frequency between the sensing clock signal and the reference clock signal. For example, the particle mass measurement device 100 according to an embodiment may calculate a difference in frequency between the sensing clock signal and the reference clock signal based on a difference between the first output signal and the second output signal which are generated in operation 803.

According to an embodiment, the controller 140 of the particle mass measurement device 100 may receive the first output signal and the second output signal from the counter 130, and may calculate the difference in frequency between the sensing clock signal and the reference clock signal based on the difference between the received first output signal and the received second output signal. For example, the controller 140 may calculate the difference in frequency between the sensing clock signal and the reference clock signal based on the difference between the first output signal and the second output signal and a length of the mask signal applied from the controller 140 to the counter 130, but a detailed description thereof will be described below.

In operation 805, the method may include, measuring mass of particles based on the calculated difference in the frequency between the sensing clock signal and the reference clock signal. For example, the particle mass measurement device 100 according to an embodiment may measure the mass or mass concentration of particles in the air based on the difference in frequency between the sensing clock signal and the reference clock signal, which is calculated in operation 804. For example, the controller 140 of the particle mass measurement device 100 may estimate a change of current particle mass with respect to reference particle mass by comparing reference data with the difference in frequency between the sensing clock signal and the reference clock signal, and may measure the mass or mass concentration of particles in the current air based on a result of estimating.

According to one or more embodiments, the ‘reference data’ may refer to data indicating a relationship between the frequency of a clock signal and the mass concentration of particle, and the corresponding data may be stored in the controller 140 or a memory electrically connected to the controller 140. The reference data may be preset or predetermined data.

According to an embodiment, the particle mass measurement device 100 may measure the mass or mass concentration of particle by using the counter 130 in operations 803 to 805, thereby reducing power consumption, compared to the case of measuring the mass or mass concentration of particle by using a mixer.

In a comparative example, in a case in which the mass or mass concentration of particle is measured using a mixer, the power consumption of the mixer is about 1.6 mW. On the other hand, in a case in which the mass or mass concentration of particle is measured using a counter, the power consumption of the counter 130 is only about 0.077 mW. Therefore, unlike the particle mass measurement device of the related art using the mixer, the particle mass measurement device 100 according to an embodiment may precisely measure the mass or mass concentration of particle while reducing power consumption.

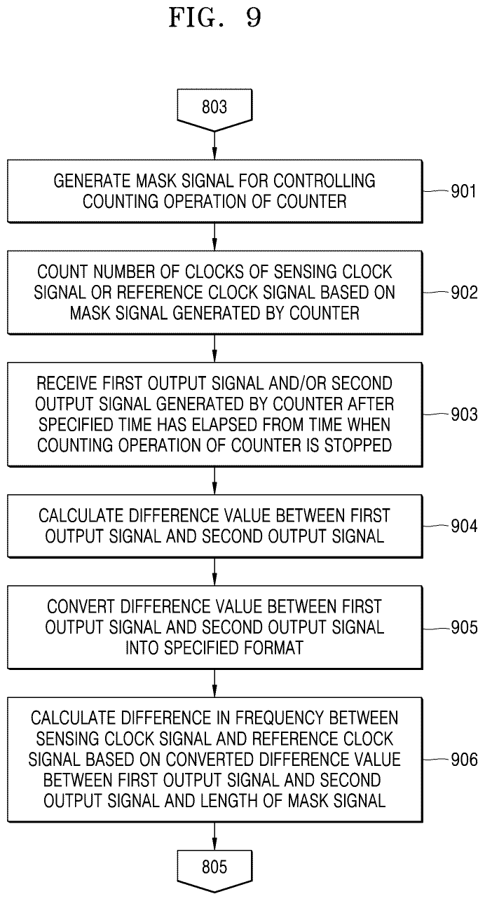

Hereinafter, an operation, performed by the particle mass measurement device 100, of calculating a difference in frequency between a sensing clock signal and a reference clock signal will be described in detail with reference to FIG. 9.

FIG. 9 is a flowchart for describing an operation, performed by the particle mass measurement device 100, of calculating a difference in frequency between a sensing clock signal and a reference clock signal, according to an embodiment.

FIG. 9 is a flowchart for describing operations 803 and 804 of FIG. 8 in detail. Hereinafter, operations, performed by the particle mass measurement device 100 of FIG. 9, of calculating the difference in frequency between the sensing clock signal and the reference clock signal will be described with reference to the elements of the particle mass measurement device 100 illustrated in FIG. 2.

Referring to FIG. 9, in operation 901, the method may include generating a mask signal. For example, the controller 140 of the particle mass measurement device 100 according to an embodiment may generate a mask signal for controlling a counting operation of the counter 130. The mask signal may be, for example, a signal for controlling the counter 130 to start or stop counting the sensing clock signal and the reference clock signal, which are generated in operations 801 and 802 above.

According to an embodiment, the controller 140 may control not only the start and stop of the counting operation of the counter 130 but also a counting operation time by adjusting a length of the mask signal. According to one or more embodiments, the ‘counting operation time’ may refer to the time from the counting start to the counting stop, and the corresponding expression may be used in the same meaning below.

For example, the controller 140 may increase the counting operation time of the counter 130 by increasing the length of the mask signal, or may decrease the counting operation time of the counter 130 by decreasing the length of the mask signal.

In operation 902, the method may include counting a number of clocks of the sensing clock signal or the reference clock signal based on the mask signal. For example, the particle mass measurement device 100 according to an embodiment may count the number of clocks of the sensing clock signal or the reference clock signal based on the mask signal generated by the counter 130 (e.g., an asynchronous counter) in operation 901.

For example, the counter 130 may generate a first output signal by receiving the mask signal from the controller 140 and then counting the number of clocks of the sensing clock signal. In addition, the counter 130 may generate a second output signal by receiving the mask signal from the controller 140 and counting the number of clocks of the reference clock signal. Operation 902 may be substantially the same as or similar to operation 803 of FIG. 8, and a redundant description thereof is omitted.

In operation 903, the method may include receiving a first output signal and a second output signal. For example, the controller 140 of the particle mass measurement device 100 according to an embodiment may receive the output signal (e.g., the first output signal or the second output signal) from the counter 130 after the specified time (e.g., T in FIG. 7) has elapsed from the time when the counting operation of the counter 130 is stopped due to stop of the input of the mask signal.

In an example case in which the counter 130 is an asynchronous counter, a delay or an offset of the output signal may occur due to characteristics of the asynchronous counter, and, as a result, a plurality of flip-flops of the counter 130 may constantly maintain output values until the specified time T has elapsed from the time when the input of the mask signal is stopped.

The controller 140 may receive the first output signal and the second output signal each in the form of a digital signal from the counter 130 the specified time T has elapsed from the time when the counting operation of the counter 130 is stopped, considering such characteristics of the asynchronous counter.

In operation 904, the method may include calculating a difference value between the first output signal and the second output signal. For example, the controller 140 of the particle mass measurement device 100 according to an embodiment may calculate a difference value between the first output signal and the second output signal, which are received in operation 903. For example, the controller 140 may compare the first output signal and the second output signal, which are output in the form of a digital signal in operation 903, and may calculate the difference value between the first output signal and the second output signal. In this case, the difference value between the first output signal and the second output signal may be expressed in a binary format.

In operation 905, the method may include converting the difference value between the first output signal and the second output signal into a specified format. For example, the controller 140 of the particle mass measurement device 100 according to an embodiment may convert the difference value between the first output signal and the second output signal, which is calculated in operation 904, into a specified format. For example, the controller 140 may convert the difference value between the first output signal and the second output signal, which is expressed in a binary format or a binary number, into a decimal format or a decimal number.

In operation 906, the method may include calculating the difference in frequency between the sensing clock signal and the reference clock signal based on the difference value between the first output signal and the second output signal. For example, the controller 140 of the particle mass measurement device 100 according to an embodiment may calculate the difference in frequency between the sensing clock signal and the reference clock signal based on the difference value between the first output signal and the second output signal, the format of which is converted in operation 905, and the length of the mask signal.

Since the output signal of the counter 130 represents the number of clocks during the length of the mask signal, the controller 140 may calculate the difference in frequency between the sensing clock signal and the reference clock signal by dividing the difference value between the first output signal and the second output signal, by the length of the mask signal as expressed in Equation 1. Here, the difference value between the first output signal and the second output signal may be converted into a decimal number.

$$frequency of sensing clock signal - frequency of reference clock signal = \frac{\begin{matrix}( difference between first output signal and \\ second output signal )\end{matrix}}{length of mask signal} \qquad [ Equation 1 ]$$

The controller 140 of the particle mass measurement device 100 according to an embodiment may calculate the mass or mass concentration of particles in the air by comparing the calculated difference in frequency between the sensing clock signal and the reference clock signal with reference data and calculating a change in the mass of particles in the air with respect to the reference mass of particle. The reference data maybe preset or predetermined data.

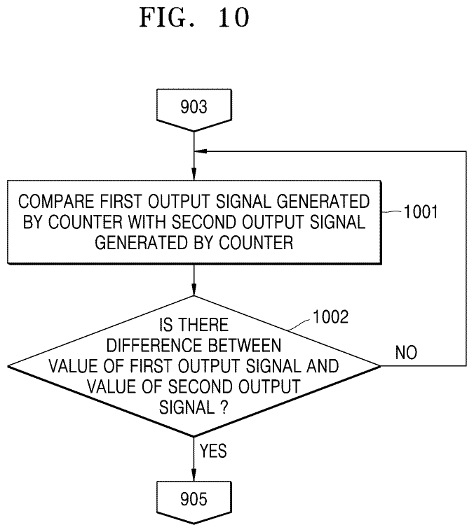

Hereinafter, an operation, performed by the controller 140, of processing a first output signal and a second output signal will be described in detail with reference to FIG. 10.

FIG. 10 is a flowchart for describing an operation of processing a first output signal and a second output signal, which are generated by the counter 130 of the particle mass measurement device 100, according to an embodiment.

FIG. 10 is a flowchart for describing operation 904 of FIG. 9 in detail. Hereinafter, operations of FIG. 10 will be described with reference to the elements of the particle mass measurement device 100 illustrated in FIG. 2.

Referring to FIG. 10, in operation 1001, the method may include comparing the first output signal received in operation 903 with the second output signal received. For example, the controller 140 of the particle mass measurement device 100 according to an embodiment may compare the first output signal received in operation 903 with the second output signal received in operation 903.

In operation 1002, the method may include determining whether there is a difference between a value of the first output signal and a value of the second output signal based on a result of the comparing in operation 1001. For example, the controller 140 of the particle mass measurement device 100 according to an embodiment may determine whether there is a difference between a value of the first output signal and a value of the second output signal based on a result of the comparing in operation 1001.

In an example case in which the mass or mass concentration of particles in the air changes, the difference between the value of the first output signal and the value of the second output signal that is the reference occurs. Therefore, the controller 140 may determine whether there is the difference between the value of the first output signal and the value of the second output signal, so as to identify a change in the mass of particles in the air.

In an example case in which it is determined in operation 1002 that there is the difference between the value of the first output signal and the value of the second output signal, the controller 140 of the particle mass measurement device 100 according to an embodiment may convert a difference value between the first output signal and the second output signal into a particular format through operation 905, and may calculate a difference in frequency between the sensing clock signal and the reference clock signal based on the converted difference value between the first output signal and the second output signal. The particular format may be a preset format. For example, the preset format may be a decimal number format.

In an example case in which it is determined in operation 1002 that there is no difference between the value of the first output signal and the value of the second output signal, the controller 140 of the particle mass measurement device 100 according to an embodiment may determine that the mass of particle has not changed and may repeat operation 1001 again.

In an example case in which it is determined in operations 1001 and 1002 that there is no difference between the first output signal and the second output signal, the particle mass measurement device 100 according to an embodiment may prevent the controller 140 from performing unnecessary calculation, and, as a result, the overall power consumption of the particle mass measurement device 100 may be reduced.

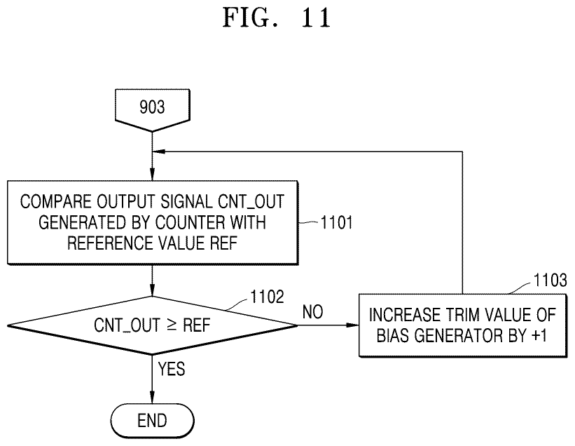

FIG. 11 is a flowchart for describing operations of adjusting magnitude of a bias voltage output by a bias generator according to an embodiment. Hereinafter, operations of adjusting the magnitude of the bias voltage of FIG. 11 are described with reference to configurations of the particle mass measurement device 100 shown in FIG. 2.

The controller 140 of the particle mass measurement device 100 according to an embodiment may adjust a gain of the first amplifier 112 constituting the sensing channel 110 and/or a gain of the second amplifier 122 constituting the reference channel 120, based on a first output signal and/or a second output signal received from the counter 130, thereby adjusting a system gain of the sensing channel 110 and/or a system gain of the reference channel 120 to satisfy an oscillation condition. The controller 140 may adjust a first bias voltage output by the first bias generator 115 and/or a second bias voltage output by the second bias generator 125, thereby adjusting the gain of the first amplifier 112 constituting the sensing channel 110 and/or the gain of the second amplifier 122 constituting the reference channel 120. For example, the controller 140 may adjust a first bias voltage value applied to the sensing channel 110 based on the first output signal generated by the first counter 131 from a sensing clock signal. In addition, the controller 140 may adjust a second bias voltage value applied to the reference channel 120 based on the second output signal generated by the second counter 132 from a reference clock signal.

Referring to FIG. 11, in operation 1101, the method may include comparing each of the first output signal and the second output signal received in operation 903 with a reference value. For example, the controller 140 of the particle mass measurement device 100 according to an embodiment may compare each of the first output signal and the second output signal received in operation 903 with a reference value. The reference value may be a preset or predetermined reference value. For example, the controller 140 may compare the first output signal received from the counter 130 with a first reference value and compare the second output signal received from the counter 130 with a second reference value.

According to an embodiment, operations of adjusting the magnitude of a bias voltage of the sensing channel 110 are described. For example, these operations are performed by the controller 140 of the particle mass measurement device 100. In operation 1101, the controller 140 may compare the first output signal received from the counter 130 with the first reference value.

In operation 1102, in a case in which the first output signal is less than the first reference value, the method may include determining that the system gain of the sensing channel 110 does not satisfy an oscillation condition of the first SAW sensor 111. For example, the controller 140 of the particle mass measurement device 100 according to an embodiment may determine that the system gain of the sensing channel 110 does not satisfy an oscillation condition of the first SAW sensor 111, increase a first trim value input to the first bias generator 115 by one step and output the first trim value (operation 1103), so that the first bias voltage supplied by first bias generator 115 to the first amplifier 112 increases, and repeatedly perform operation 1101 again.

In contrast, in operation 1102, in an example case in which the first output signal is greater than or equal to the first reference value, the method may include determining that the system gain of the sensing channel 110 satisfies the oscillation condition of the first SAW sensor 111. For example, the controller 140 may determine that the system gain of the sensing channel 110 satisfies the oscillation condition of the first SAW sensor 111, and end the operation of adjusting the magnitude of the bias voltage output by the bias generator.

Next, operations, performed by the controller 140 of the particle mass measurement device 100, of adjusting the magnitude of the bias voltage of the reference channel 120 are described. Referring to FIG. 11, in operation 1101, the controller 140 of the particle mass measurement device 100 according to an embodiment may compare the second output signal received in operation 903 with the second reference value.

In operation 1102, in an example case in which the second output signal is less than the second reference value, the controller 140 of the particle mass measurement device 100 may determine that the system gain of the sensing channel 110 does not satisfy an oscillation condition of the second SAW sensor 111, increase a second trim value input to the second bias generator 125 by one step and output the second trim value (operation 1103), so that the first the second bias voltage supplied by the second bias generator 125 to the second amplifier 122 increases, and repeatedly perform operation 1101 again.

On the other hand, in operation 1102, in an example case in which the second output signal is greater than or equal to the second reference value, the controller 140 may determine that the system gain of the sensing channel 110 satisfies the oscillation condition of the second surface acoustic wave sensor 111, and end the operation of adjusting the magnitude of the bias voltage output by the bias generator.

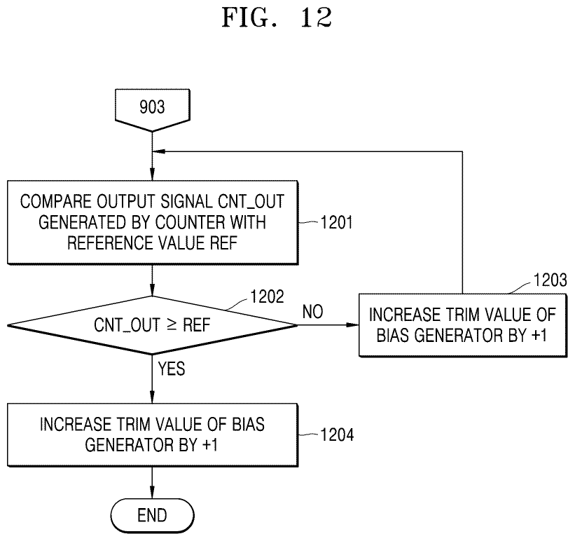

FIG. 12 is a flowchart for describing operations of adjusting magnitude of a bias voltage output by a bias generator according to an embodiment. Hereinafter, operations of adjusting the magnitude of the bias voltage of FIG. 12 are described with reference to configurations of the particle mass measurement device 100 shown in FIGS. 11 and 2.

In operation 1201, the operation, performed by the controller 140, of adjusting the magnitude of the bias voltage may be the same as operation 1101 described with reference to FIG. 11. For example, in operation 1201, the method may include comparing each of the first output signal and the second output signal received in operation 903 with a reference value.

In operation 1202, in a case in which a first output signal is less than a first reference value, the method may include determining that a system gain of the sensing channel 110 does not satisfy an oscillation condition of the first SAW sensor 111. For example, the controller 140 of the particle mass measurement device 100 according to an embodiment may determine that a system gain of the sensing channel 110 does not satisfy an oscillation condition of the first SAW sensor 111, increase a first trim value input to the first bias generator 115 by one step and output the first trim value (operation 1203), so that a first bias voltage supplied by first bias generator 115 to the first amplifier 112 increases, and repeatedly perform operation 1201 again.

On the other hand, in operation 1102, in an example case in which the first output signal is greater than or equal to the first reference value, the method may include determine that the system gain of the sensing channel 110 satisfies the oscillation condition of the first SAW sensor 111. For example, the controller 140 may determine that the system gain of the sensing channel 110 satisfies the oscillation condition of the first SAW sensor 111, increase the first trim value input to the first bias generator 115 by one step and output the first trim value (operation 1204), so that the first bias voltage supplied by first bias generator 115 to the first amplifier 112 increases, and end the operation of adjusting the magnitude of the bias voltage output by the bias generator. Unlike the embodiment of FIG. 11, according to another embodiment, the controller 140 may not immediately end the operation of adjusting the magnitude of the bias voltage when the first output signal is greater than or equal to the first reference value, but increase the first trim value input to the first bias generator 115 by one step and output the first trim value (operation 1204), and end the operation of adjusting the magnitude of the bias voltage output by the bias generator.

The operation, performed by the controller 140 of the particle mass measurement device 100, of adjusting the magnitude of the bias voltage of the reference channel 120 is mostly similar to the operation of adjusting the magnitude of the bias voltage of the sensing channel 110, and thus, redundant descriptions thereof are omitted.

Meanwhile, the particle mass measurement method of the particle mass measurement device may be recorded on a computer-readable recording medium on which one or more programs including instructions for executing the particle mass measurement method are recorded. Examples of the computer-readable recording medium may include hardware devices specially configured to store and execute program commands, such as magnetic media (e.g., hard disk, floppy disk, magnetic tape, etc.), optical media (e.g., compact disc read-only memory (CD-ROM), digital versatile disc (DVD), etc.), magneto-optical media (e.g., floptical disk, etc.), read-only memory (ROM), random access memory (RAM), and flash memory. Examples of the program instructions may include not only machine language code generated by a compiler but also high-level language code that is executable using an interpreter by a computer.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A particle mass measurement device comprising:
a sensing channel comprising:
a first surface acoustic wave (SAW) sensor configured to generate a first SAW,
a first amplifier configured to amplify the first SAW generated by the first SAW sensor, and
a first bias generator configured to apply a first bias voltage to the first amplifier, the sensing channel being configured to generate a sensing clock signal;
a reference channel comprising:
a second SAW sensor configured to generate a second SAW,
a second amplifier configured to amplify the second SAW generated by the second SAW sensor,
a second bias generator configured to apply a second bias voltage to the second amplifier, the reference channel being configured to generate a reference clock signal;
a counter configured to:
generate a first output signal based on the sensing clock signal, and
generate a second output signal based on the reference clock signal; and
a controller configured to: adjust a first magnitude of the first bias voltage based on the first output signal, or adjust a second magnitude of the second bias voltage based on the second output signal,
calculate a difference in frequency between the sensing clock signal and the reference clock signal based on a difference between the first output signal and the second output signal, and
measure a mass of particle based on the difference in frequency between the sensing clock signal and the reference clock signal.

2. The particle mass measurement device of claim 1, wherein
a first gain of the first amplifier is proportional to the first magnitude of the first bias voltage, and
a second gain of the second amplifier is proportional to the second magnitude of the second bias voltage.

3. The particle mass measurement device of claim 1, wherein
the first bias generator is configured to generate the first bias voltage with a first voltage level based on a first trim value output by the controller, and
the second bias generator is configured to generate the second bias voltage with a second voltage level based on a second trim value output by the controller.

4. The particle mass measurement device of claim 3, wherein the controller is further configured to:
compare the first output signal with a first reference value, based on the first output signal being less than the first reference value, increase the first trim value by one step, and compare the first output signal with the first reference value again, and
compare the second output signal with a second reference value, based on the second output signal being less than the second reference value, increase the second trim value by one step, and compare the second output signal with the second reference value again.

5. The particle mass measurement device of claim 1, wherein
the first SAW sensor and the first amplifier form a first feedback loop, and
the second SAW sensor and the second amplifier form a second feedback loop.

6. The particle mass measurement device of claim 1, further comprising:
a first buffer having one end connected to the sensing channel and another end connected to the counter, the first buffer configured to adjust a voltage of the sensing clock signal transmitted from the sensing channel to the counter; and
a second buffer having one end connected to the reference channel and another end connected to the counter, the second buffer configured to adjust a voltage of the reference clock signal transmitted from the reference channel to the counter.

7. The particle mass measurement device of claim 1, wherein the controller is further configured to control the sensing channel to generate the sensing clock signal after a second time has elapsed from a first time when the reference clock signal is generated by the reference channel.

8. The particle mass measurement device of claim 1, wherein the counter comprises:
a first counter electrically connected to the sensing channel, and configured to generate the first output signal based on the sensing clock signal; and
a second counter electrically connected to the reference channel, and configured to generate the second output signal based on the reference clock signal,
wherein the first counter is an asynchronous counter comprising a plurality of first flip-flops, and
wherein the second counter is an asynchronous counter comprising a plurality of second flip-flops.

9. The particle mass measurement device of claim 8, wherein
the controller is further configured to generate a mask signal for controlling a counting operation of the counter, and
the counter is further configured to count a number of clocks of the sensing clock signal or the reference clock signal based on the mask signal received from the controller.

10. The particle mass measurement device of claim 9, wherein the controller is further configured to receive the first output signal or the second output signal from the counter after a second time has elapsed from a first time when the counting operation of the counter is stopped.

11. The particle mass measurement device of claim 9, wherein the controller is further configured to:
convert a difference value between the first output signal and the second output signal into a specific format, and
calculate a difference in frequency between the frequency of the sensing clock signal and the reference clock signal based on the converted difference value between the first output signal and the second output signal and a length of the mask signal.

12. The particle mass measurement device of claim 11, wherein the controller is further configured to:
convert the difference value between the first output signal and the second output signal, which is output as a digital signal, into a decimal number, and
calculate the difference in frequency between the frequency of the sensing clock signal and the reference clock signal by dividing the difference value between the first output signal and the second output signal, which is converted into the decimal number, by the length of the mask signal.

13. An operating method of a particle mass measurement device, the operating method comprising:
generating a sensing clock signal using a sensing channel by:
generating, by a first surface acoustic wave (SAW) sensor, a first SAW,
amplifying, by a first amplifier, the first SAW generated by the first SAW sensor, and
applying, by a first bias generator, a first bias voltage to the first amplifier;
generating a reference clock signal using a reference channel by:
generating, by a second SAW sensor, a second SAW,
amplifying, by a second amplifier, the second SAW generated by the second SAW sensor,
applying, a second bias generator, a second bias voltage to the second amplifier;
generating a first output signal using an asynchronous counter based on the sensing clock signal;
generating a second output signal using the asynchronous counter based on the reference clock signal;
adjusting, by a controller, a first magnitude of the first bias voltage based on the first output signal, or adjust a second magnitude of the second bias voltage based on the second output signal;
calculating, by the controller, a difference in frequency between the sensing clock signal and the reference clock signal based on a difference between the first output signal and the second output signal; and
measuring, by the controller, a mass of particle based on the difference in frequency between the sensing clock signal and the reference clock signal.

14. The operating method of claim 13, wherein the generating of the sensing clock signal comprises generating the sensing clock signal after a second time has elapsed from a first time when the reference clock signal is generated.

15. A computer-readable recording medium having recorded thereon a program for implementing an operating method of a particle mass measurement device, the operating method comprising:
generating a sensing clock signal using a sensing channel by:
generating, by a first surface acoustic wave (SAW) sensor, a first SAW,
amplifying, by a first amplifier, the first SAW generated by the first SAW sensor, and
applying, by a first bias generator, a first bias voltage to the first amplifier;
generating a reference clock signal using a reference channel by:
generating, by a second SAW sensor, a second SAW,
amplifying, by a second amplifier, the second SAW generated by the second SAW sensor,
applying, a second bias generator, a second bias voltage to the second amplifier;
generating a first output signal using an asynchronous counter based on the sensing clock signal;
generating a second output signal using the asynchronous counter based on the reference clock signal;
adjusting, by a controller, a first magnitude of the first bias voltage based on the first output signal, or adjust a second magnitude of the second bias voltage based on the second output signal;
calculating, by the controller, a difference in frequency between the sensing clock signal and the reference clock signal based on a difference between the first output signal and the second output signal; and
measuring, by the controller, a mass of particle based on the difference in frequency between the sensing clock signal and the reference clock signal.
